(19) United States
(12) Patent Application Publication
(10) Pub. No.: US 2024/0416469 A1
(43) Pub. Date: Dec. 19, 2024

(54) DUST COLLECTION SYSTEM FOR POWER TOOL

(71) Applicant: MAKITA CORPORATION, Anjo-shi (JP)

(72) Inventors: Hitoshi IIDA, Anjo-shi (JP); Masanori Furusawa, Anjo-shi (JP)

(73) Assignee: MAKITA CORPORATION, Anjo-shi (JP)

(21) Appl. No.: 18/618,608

(22) Filed: Mar. 27, 2024

(30) Foreign Application Priority Data
Jun. 13, 2023 (JP) 2023-097206

(51) Int. Cl. B23Q 11/00; B25D 17/20

(52) U.S. Cl. CPC B23Q 11/0046; B23Q 11/0071; B25D 17/20; B25D 2217/0065

(57) ABSTRACT

A dust collection system for a power tool includes a power tool including an AC motor drivable with a switch and a tool-body power path extending from utility power to the AC motor, and a dust collection attachment attachable to the power tool to collect dust produced by the power tool in use and including a suction portion, a dust collector, a fan, a DC motor, a battery pack, and a dust-collector power path extending from the battery pack to the DC motor and electrically separate from the tool-body power path with the dust collection attachment attached to the power tool. The power tool includes a responsive unit that drives the DC motor in response to an operation on the switch with the responsive unit electrically separate from a signal path of the switch.

### CROSS-REFERENCE TO RELATED APPLICATIONS

This application claims the benefit of priority to Japanese Patent Application No. 2023-097206, filed on Jun. 13, 2023, the entire contents of which are hereby incorporated by reference.

### BACKGROUND

### 1. Technical Field

The disclosure relates to a dust collection system for a power tool including a power tool and a dust collection attachment attached to the power tool to collect dust produced by the power tool in use.

### 2. Description of the Background

When a power tool such as a hammer drill is used to machine a target material such as a concrete or stone piece, a dust collection attachment is attached to the power tool to avoid dispersion of dust produced from the target material. The dust collection attachment includes a suction portion that sucks dust, a dust collector that collects sucked dust, and a dust collection motor including a fan that generates a suction force, as described in Japanese Patent No. 6211433.

The casing of the dust collection attachment is slid onto the body of the power tool, for example, from below, to attach the dust collection attachment to the power tool. In the attached state, a male plug in the dust collection attachment is located in and electrically connected to a female connector in the power tool. The power tool receives utility power through a power cable. When the trigger is operated to turn on the switch, the utility power is used to drive a drive motor and is also supplied to a controller in the dust collection attachment. The controller converts the supplied utility power to direct current (DC) and uses the DC to drive a dust collection motor, which is a DC motor. When the switch is turned off, the power stops being supplied from the power tool to the controller, thus stopping the dust collection motor.

### BRIEF SUMMARY

In the known dust collection system for the power tool, the power tool and the dust collection attachment are electrically connected to each other, and the DC motor in the dust collection attachment operates in response to the switch being on and off on the power tool. Thus, the DC motor produces noise that may reach the utility power through the power path in the power tool. Such a power tool may fail an electromagnetic interference (EMI) test, and is to take measures against noise.

One or more aspects of the disclosure are directed to a dust collection system for a power tool that prevents transmission of noise from a direct current motor in a dust collection attachment to a power path in a power tool.

A first aspect of the disclosure provides a dust collection system for a power tool, the system including:

a power tool including
an alternating current motor drivable with a switch, and
a tool-body power path extending from utility power to the alternating current motor; and

a dust collection attachment attachable to the power tool to collect dust produced by the power tool in use, the dust collection attachment including
a suction portion,
a dust collector configured to capture dust sucked through the suction portion,
a fan configured to generate a suction force in the suction portion,
a direct current motor configured to rotate the fan,
a battery pack configured to supply power to the direct current motor, and
a dust-collector power path extending from the battery pack to the direct current motor, the dust-collector power path being electrically separate from the tool-body power path with the dust collection attachment attached to the power tool,

the power tool including a responsive unit configured to drive the direct current motor in response to an operation on the switch with the responsive unit electrically separate from a signal path of the switch.

The dust collection system according to the above aspect of the disclosure prevents transmission of noise from the direct current motor in the dust collection attachment to the power path in the power tool.

### BRIEF DESCRIPTION OF DRAWINGS

FIG. 1 is a longitudinal central sectional view of a dust collection system for a power tool.

FIG. 2 is an enlarged view of a portion on the left of line A-A in FIG. 1.

### DETAILED DESCRIPTION

Embodiments of the disclosure will now be described with reference to the drawings.

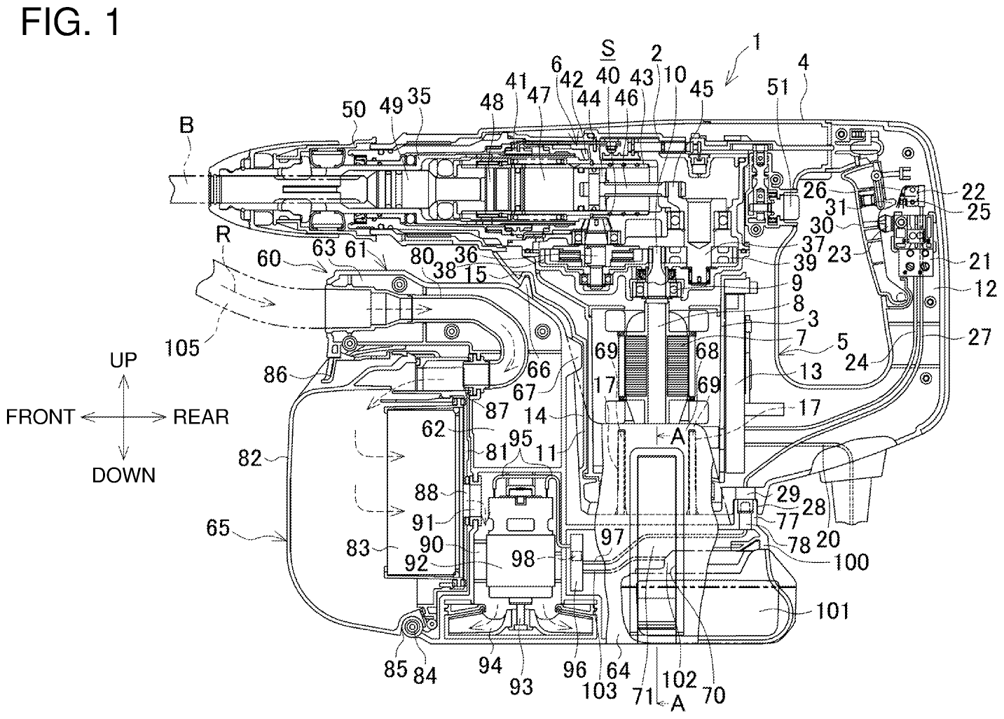

FIG. 1 is a longitudinal central sectional view of an example dust collection system S for a power tool (hereafter simply referred to as a dust collection system). The dust collection system S includes a hammer drill (power tool) 1 to which a dust collection attachment 60 is attached.

The hammer drill 1 includes a housing including an inner housing 2, a motor housing 3, an upper outer housing 4, and a lower outer housing 5. The inner housing 2 accommodates a striking assembly 6 extending in the front-rear direction. The motor housing 3 is connected to a lower portion of the inner housing 2. The motor housing 3 accommodates a motor (an alternating current motor, or an AC motor) 7. The motor 7 is held in the motor housing 3 with a rotational shaft 8 extending upward. The rotational shaft 8 has its upper portion supported by a bearing 9 held in the inner housing 2. The rotational shaft 8 includes a pinion 10 on its upper end. The pinion 10 protrudes into the inner housing 2.

The upper outer housing 4 is located above the motor housing 3 and covers the outer surface of the inner housing 2.

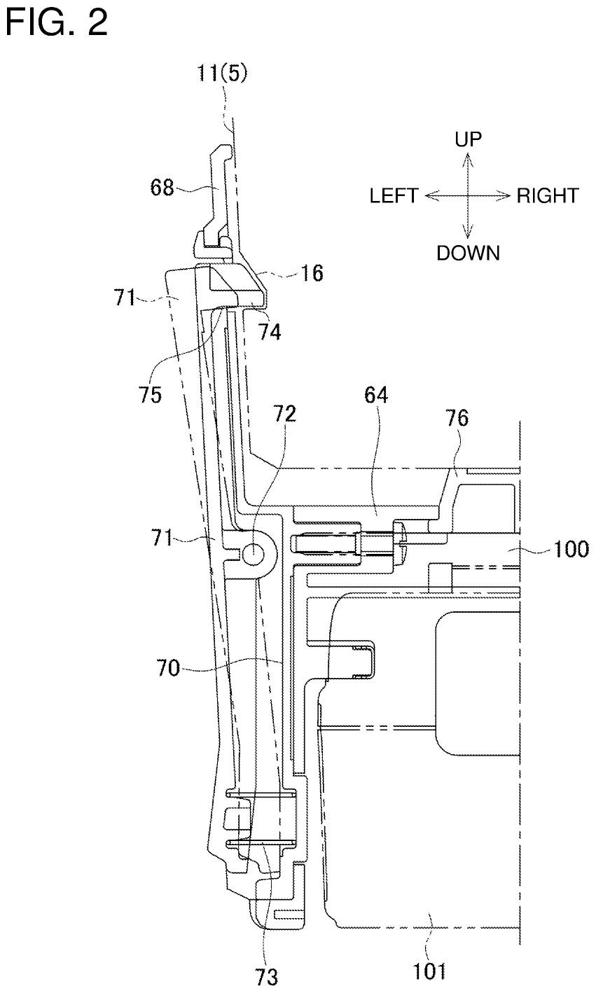

The lower outer housing 5 includes a front cylinder 11 and a handle 12. The front cylinder 11 covers the outer surface of the motor housing 3 from below. The front cylinder 11 accommodates a tool-body controller 13 behind the motor housing 3. The tool-body controller 13 includes a control circuit board (not shown) and extends vertically. The front cylinder 11 has a front guide groove 14 at the lateral center of its front surface. The front guide groove 14 extends vertically. An upper engagement recess 15 is located upward and frontward from the front guide groove 14 to receive the dust collection attachment 60. As shown in FIG. 2, the front cylinder 11 has lateral engagement recesses 16 on its right and left surfaces to receive the dust collection attachment 60. A pair of lateral guide grooves 17 are located on the front and rear of each lateral engagement recess 16. The lateral guide grooves 17 extend upward from the lower end of the front cylinder 11.

The handle 12 extends rearward from a lower portion of the front cylinder 11 and then upward to connect to the rear end of the upper outer housing 4.

The handle 12 is connected to a power cable 20 on its lower portion. The power cable 20 is electrically connected to the tool-body controller 13. The handle 12 includes a main switch (switch) 21 and a subswitch (second switch) 22 above the power cable 20. The main switch 21 pushes a plunger 23 forward. The main switch 21 is connected to a main lead wire (signal path) 24. The main lead wire 24 is electrically connected to the tool-body controller 13. The main lead wire 24 is used to input an on-signal into the tool-body controller 13 when the plunger 23 is pushed. The power path extending from the power cable 20 to the motor 7 through the tool-body controller 13 is an example of a tool-body power path extending from utility power to an AC motor in one or more aspects of the disclosure. The power path is also an example of a tool-body power path extending from the utility power to the AC motor through a tool-body controller in one or more aspects of the disclosure.

The subswitch 22 pushes a plunger 25 forward. The subswitch 22 includes a lever 26 on its front portion. The subswitch 22 is connected to a sub-lead wire 27. The sub-lead wire 27 extends between the main switch 21 and the inner surface of the handle 12 downward in the handle 12.

The lower surface of the front cylinder 11 in the lower outer housing 5 has a connection port 28 below the tool-body controller 13. The connection port 28 is open downward. The connection port 28 includes a female connector 29 extending downward. The sub-lead wire 27 is connected to the female connector 29.

The handle 12 includes a switch lever 30 located frontward from the main switch 21 and the subswitch 22. The switch lever 30 is pivotable in the front-rear direction about its lower end. In a normal state, the switch lever 30 is in contact with the plunger 23 in the main switch 21 and protrudes frontward from the handle 12. The switch lever 30 includes a press portion 31 above the position at which the switch lever 30 is in contact with the plunger 23. The press portion 31 is located frontward from the lever 26 in the subswitch 22.

When the protruding switch lever 30 is pushed backward, the switch lever 30 pushes the plunger 23 to turn on the main switch 21, and also pushes the plunger 25 with the press portion 31 and the lever 26 to turn on the subswitch 22. With the press portion 31 having a predetermined length, the subswitch 22 is turned on earlier than the main switch 21.

The striking assembly 6 includes a tool holder 35. The tool holder 35 is rotatably held in a front portion of the inner housing 2. The tool holder 35 is cylindrical and extends in the front-rear direction. A countershaft 36 is supported in front of the rotational shaft 8 in the inner housing 2. The countershaft 36 extends vertically. A crankshaft 37 is supported behind the rotational shaft 8 in the inner housing 2. The crankshaft 37 extends vertically. The countershaft 36 receives a gear 38. The crankshaft 37 receives a gear 39. The gear 38 and the gear 39 mesh with the pinion 10 on the rotational shaft 8. The countershaft 36 receives a first bevel gear 40 on its upper end.

The tool holder 35 is connected to a switching sleeve 41 with splines. Behind the switching sleeve 41, a second bevel gear 42 is externally attached to the rear end of the tool holder 35 in a rotatable manner. The second bevel gear 42 meshes with the first bevel gear 40 on the countershaft 36. With the switching sleeve 41 engaged at a backward position, the second bevel gear 42 transmits rotation of the first bevel gear 40 to the tool holder 35. The switching sleeve 41 is switched between a forward position and the backward position with a switching knob 51. The switching knob 51 is located on the rear surface of the upper outer housing 4.

The inner housing 2 holds a cylinder 43 in its rear portion. The cylinder 43 is coaxially placed in a rear portion of the tool holder 35. The cylinder 43 accommodates a piston 44 movable back and forth. The crankshaft 37 includes an eccentric pin 45 protruding from its upper portion. The piston 44 and the eccentric pin 45 are connected with a connecting rod 46. The cylinder 43 accommodates a striker 48 movable back and forth in front of the piston 44, with an air chamber 47 located between the piston 44 and the striker 48. The tool holder 35 includes an impact bolt 49 in front of the striker 48. The impact bolt 49 comes in contact with a bit B placed in the front end of the tool holder 35. The tool holder 35 includes an operation sleeve 50 externally attached to its front portion. The operation sleeve 50 is operable to attach and detach the bit B.

In the hammer drill 1, the switch lever 30 is pushed to turn on the main switch 21. The main switch 21 provides an on-signal through the main lead wire 24 to the tool-body controller 13, which then supplies power to the motor 7 to rotate the rotational shaft 8. The crankshaft 37 then rotates to move the piston 44 back and forth with the connecting rod 46. This causes the striker 48 to strike the bit B with the impact bolt 49. When the switching sleeve 41 is switched to the backward position with the switching knob 51, the mode is switched to a hammer drill mode. In the hammer drill mode, the rotation of the countershaft 36 is transmitted to the tool holder 35 through the second bevel gear 42. When the switching sleeve 41 is switched to the forward position, the mode is switched to a hammer mode. In the hammer mode, striking is simply performed without the tool holder 35 rotating.

The dust collection attachment 60 will now be described.

The dust collection attachment 60 includes a box-like casing 61. The casing 61 includes a main section 62, a front protruding section 63, and a rear protruding section 64. The main section 62 extends vertically. The front protruding section 63 extends frontward from an upper portion of the main section 62. A dust box 65 is detachably attachable to the front of the main section 62 and the bottom of the front protruding section 63. The rear protruding section 64 extends rearward from a lower portion of the main section 62. The main section 62 and the rear protruding section 64 can be fastened to the hammer drill 1.

The main section 62 includes an upper engagement protrusion 66 protruding upward on its upper surface. The upper engagement protrusion 66 is placeable into the upper engagement recess 15 on the front cylinder 11 in the hammer drill 1.

The main section 62 includes an engagement plate 67 on an upper portion of its rear surface. The engagement plate 67 extends vertically. The engagement plate 67 is engageable with the front guide groove 14 on the front surface of the front cylinder 11.

A pair of right and left side plates 68 extend from the rear surface of the main section 62 to the upper surface of the rear protruding section 64. The space between the pair of side plates 68 receives the front cylinder 11 in the hammer drill 1 from above. Each side plate 68 has a pair of front and rear ridges 69 on its inner surface. The pair of ridges 69 are fitted in the pair of lateral guide grooves 17 on the side surfaces of the front cylinder 11.

Each side plate 68 has a recess 70 extending vertically on its outer surface. The recess 70 receives a hook plate 71. The hook plate 71 is a strip plate fitted in the recess 70 and extending vertically. As shown in FIG. 2, the hook plate 71 has the inner surface connected to a shaft 72 in its intermediate portion. The shaft 72 extends in the front-rear direction in the recess 70. The hook plate 71 is pivotable about the shaft 72. A lower portion of the hook plate 71 is pressed laterally outward by a coil spring 73 between the hook plate 71 and the inner surface of the recess 70. Thus, the hook plate 71 is at a locking position at which its upper portion is urged laterally inward, as indicated by the solid lines in FIG. 2. The hook plate 71 includes, on its upper end, an engagement tab 74 protruding inward. At the locking position, the engagement tab 74 protrudes inward from the side plate 68 through a through-hole 75 in the recess 70. With the dust collection attachment 60 attached to the hammer drill 1, the engagement tab 74 is engaged with the lateral engagement recess 16 on the front cylinder 11. When the lower portion of the hook plate 71 is pressed toward the recess 70, the hook plate 71 inclines to an unlocking position at which the engagement tab 74 is disengaged from the lateral engagement recess 16, as indicated by the two-dot-dash lines in FIG. 2.

The rear protruding section 64 includes a receiver 76 on its upper surface. With the dust collection attachment 60 attached, the receiver 76 is in contact with the lower surface of the front cylinder 11. The rear protruding section 64 includes a connection cylinder 77 protruding upward on its upper surface behind the receiver 76. The connection cylinder 77 is located on the rear protruding section 64 at its lateral center. The connection cylinder 77 holds a male connector 78 extending upward. With the dust collection attachment 60 attached, the connection cylinder 77 is connected to the connection port 28 on the lower surface of the front cylinder 11. The male connector 78 is thus connected to the female connector 29 in the connection port 28.

The front protruding section 63 accommodates a duct 80. The duct 80 has the front end (suction portion) that is open frontward at the front surface of the front protruding section 63. The duct 80 extends rearward in the front protruding section 63 and turns around in the main section 62. The duct 80 has the lower end that is open at the front surface of the main section 62 below the front protruding section 63.

The dust box (dust collector) 65 is attached to the casing 61 from the front below the front protruding section 63. The dust box 65 includes a lid 81 and a box body 82 that are hinged together at their lower ends. The lid 81 holds a filter 83 on its front inner surface. The box body 82 covers the filter 83 from the front.

The main section 62 includes an engagement shaft 84 extending laterally at the lower end of its front surface. The box body 82 has a receiving recess 85 extending laterally on its lower surface. The engagement shaft 84 is engaged with the receiving recess 85, and an elastic strip 86 at the upper end of the lid 81 is engaged with the lower surface of the front protruding section 63. The dust box 65 is thus detachably attached to the casing 61. The lid 81 has an entry port 87 in its upper portion and an exit port 88 in its lower portion. The entry port 87 is connected to the lower end of the duct 80. The exit port 88 is located behind the filter 83.

The main section 62 includes a motor compartment 90 defined behind the exit port 88. With the dust box 65 attached, the exit port 88 is aligned with an opening 91 in the front surface of the motor compartment 90 and connected to the motor compartment 90.

The motor compartment 90 accommodates a dust collection motor (DC motor) 92. The dust collection motor 92 is held with a rotational shaft 93 extending downward. A dust collection fan (fan) 94 is fixed to the rotational shaft 93. The main section 62 has outlets (not shown) in its right and left surfaces radially outward from the dust collection fan 94.

The dust collection motor 92 is connected to positive and negative lead wires 95. The lead wires 95 extend through a partition between the main section 62 and the rear protruding section 64 to the internal space of the rear protruding section 64. The rear protruding section 64 accommodates a dust-collector controller 96 including a control circuit board (not shown). The lead wires 95 are electrically connected to the dust-collector controller 96. The dust-collector controller 96 is electrically connected to the male connector 78 through a signal lead wire 97.

The rear protruding section 64 accommodates a battery mount 100. A battery pack 101 is slid on and attached to the battery mount 100 from the rear to supply power to the dust collection attachment 60. The battery mount 100 includes a terminal block 102. The terminal block 102 is electrically connected to the battery pack 101 attached to the battery mount 100. The terminal block 102 is electrically connected to the dust-collector controller 96 through a power lead wire 103. A power path extending from the battery pack 101 to the dust collection motor 92 through the dust-collector controller 96 is an example of a dust-collector power path extending from a battery pack to a DC motor in one or more aspects of the disclosure.

The dust-collector controller 96 includes an indicator lamp (indicator) 98. The indicator lamp 98 is exposed on the side surface of the rear protruding section 64. The indicator lamp 98 is, for example, a light-emitting diode (LED). The dust-collector controller 96 monitors the power level of the battery pack 101 attached to the battery mount 100. When the power level of the battery pack 101 decreases to less than or equal to a predetermined threshold, the dust-collector controller 96 turns on or flashes the indicator lamp 98 to indicate the decrease in the power level.

The rear protruding section 64 is placed below the front cylinder 11 in the hammer drill 1, with the ridges 69 on the side plates 68 vertically aligned with the lateral guide grooves 17 on the front cylinder 11. The dust collection attachment 60 is then vertically moved relative to the hammer drill 1. This causes the ridges 69 to fit into the lateral guide grooves 17 from below, and also causes the upper engagement protrusion 66 on the main section 62 to fit into the upper engagement recess 15 on the front cylinder 11 from below. The engagement plate 67 on the main section 62 engages with the front guide groove 14 on the front cylinder 11 from below.

The front cylinder 11 moving relatively downward comes in contact with the hook plates 71 on the side plates 68 and causes the hook plates 71 to pivot from the locking position to the unlocking position. This allows relative movement of the dust collection attachment 60. With the dust collection attachment 60 attached, the engagement tabs 74 on the hook plates 71 are at the locking position and engaged with the lateral engagement recesses 16 on the front cylinder 11. This restricts downward movement of the dust collection attachment 60 relative to the hammer drill 1. The attachment of the dust collection attachment 60 is thus complete.

Upon completion of the attachment, the connection cylinder 77 on the rear protruding section 64 is connected to the connection port 28 on the front cylinder 11, and the male connector 78 is connected to the female connector 29. The subswitch 22 is thus electrically connected to the dust-collector controller 96 through the sub-lead wire 27 and the signal lead wire 97.

The bit B is attached to the hammer drill 1. The bit B is a dust suction bit having a dust suction path along its axis with a suction port at the front end. The bit can externally receive a hose fitting (not shown) on its outer circumference. A flexible hose 105 is connected between the hose fitting and the front end of the duct 80 in the dust collection attachment 60 in which a suction force is generated.

This defines a dust collection path R to allow air to flow between the bit B and the dust collection attachment 60. As indicated by the dashed arrows in FIG. 1, the dust collection path R extends from the bit B to the outlets through the flexible hose 105, the duct 80, the dust box 65, and the motor compartment 90.

To perform work using the dust collection system S, the switch lever 30 is pushed with the tip of the bit B pressed against the target surface of a target material. This turns on the subswitch 22 first. The subswitch 22 provides an on-signal through the sub-lead wire 27 and the signal lead wire 97 to the dust-collector controller 96. The dust-collector controller 96 receives power from the battery pack 101 through the terminal block 102 and the power lead wire 103, and supplies power to the dust collection motor 92 through the lead wires 95. This drives the dust collection motor 92 to rotate the rotational shaft 93 and the dust collection fan 94. This causes the dust collection path R to have a negative pressure to generate a suction force at the tip opening of the bit B. The subswitch 22, the sub-lead wire 27, and the signal lead wire 97 are examples of a responsive unit in one or more aspects of the disclosure. The sub-lead wire 27 and the signal lead wire 97 are examples of a second signal path in one or more aspects of the disclosure.

The main switch 21 is turned on after the subswitch 22 is turned on. The main switch 21 provides an on-signal through the main lead wire 24 to the tool-body controller 13. The tool-body controller 13 receives utility power through the power cable 20 and supplies operating power to the motor 7. This drives the motor 7 to rotate the rotational shaft 8, which then rotates the countershaft 36 and the crankshaft 37. The piston 44 reciprocates independently of whether the hammer drill mode or the hammer mode is selected. This causes the striker 48 to strike the bit B with the impact bolt 49.

The dust produced from the target material is sucked into the dust suction path in the bit B and enters the duct 80 through the flexible hose 105. The dust then enters the dust box 65 through the dust collection path R, is captured by the filter 83, and is collected in the box body 82.

Any noise generated in the dust collection motor 92 during work does not transmit to the power path or the signal path in the hammer drill 1, which is electrically separate from the dust collection motor 92.

When the work is complete, the switch lever 30 is released and the main switch 21 is turned off. This causes the tool-body controller 13 to stop power supply to the motor 7 and deactivate the hammer drill 1.

When the switch lever 30 is released, the dust-collector controller 96 waits for a preset delay time (several seconds) to elapse after determining that the subswitch 22 has been turned off. After the delay time, the dust-collector controller 96 stops power supply to the dust collection motor 92. This causes dust remaining in the dust collection path R to move into the dust box 65 when the hammer drill 1 is deactivated.

To detach the dust collection attachment 60 from the hammer drill 1, the lower portions of the right and left hook plates 71 are pressed to move the hook plates 71 to the unlocking position. This disengages the engagement tabs 74 from the lateral engagement recesses 16 on the front cylinder 11 to allow relative movement of the dust collection attachment 60. The dust collection attachment 60 is relatively moved away from the hammer drill 1 reversely from when the dust collection attachment 60 is attached. This disengages the ridges 69 on the side plates 68 from the lateral guide grooves 17 on the front cylinder 11, and also disengages the engagement plate 67 on the main section 62 downward from the front guide groove 14. At the same time, the upper engagement protrusion 66 on the main section 62 is removed from the upper engagement recess 15 on the front cylinder 11. The detachment of the dust collection attachment 60 is thus complete.

To discard dust in the dust box 65, the elastic strip 86 is pushed down to be released from the front protruding section 63. The dust box 65 is pulled forward about the engagement shaft 84 to be detached from the casing 61. The lid 81 is opened to discard dust in the box body 82.

As described above, the dust collection system S includes the hammer drill 1 including the motor 7 drivable on utility power with the main switch 21 that is operable using the switch lever 30. The dust collection system S also includes the dust collection attachment 60 attachable to the hammer drill 1 to collect dust produced by the hammer drill 1 in use. The dust collection attachment 60 includes the duct 80, the dust box 65 that captures dust sucked through the duct 80, the dust collection fan 94 that generates a suction force in the duct 80, the dust collection motor 92 that rotates the dust collection fan 94, and the battery pack 101 to supply power to the dust collection motor 92.

With the dust collection attachment 60 attached to the hammer drill 1, the tool-body power path extending from the power cable 20 to the motor 7 is electrically separate from the dust-collector power path extending from the battery pack 101 to the dust collection motor 92. The dust collection system S includes the responsive unit (the subswitch 22, the sub-lead wire 27, and the signal lead wire 97) that drives the dust collection motor 92 in response to an operation on the main switch 21 with the responsive unit electrically separate from the signal path of the main switch 21.

This prevents transmission of noise from the dust collection motor 92 to the power path in the hammer drill 1. The tool can thus pass the EMI test without any measures against noise.

The hammer drill 1 includes the tool-body controller 13 that controls the motor 7 in response to an operation on the main switch 21. The power path extending from the utility power to the motor 7 through the tool-body controller 13 is electrically separate from the power path extending from the battery pack 101 to the dust collection motor 92.

With the tool-body controller 13, noise from the dust collection motor 92 is prevented from transmitting to the power path in the hammer drill 1.

The responsive unit includes the subswitch 22 on the hammer drill 1. The subswitch 22 is separate from the main switch 21 and operable in response to an operation on the main switch 21. The responsive unit also includes the sub-lead wire 27 and the signal lead wire 97 electrically connecting the subswitch 22 and the dust collection motor 92 with the dust collection attachment 60 attached to the hammer drill 1.

The dust collection motor 92 can thus operate in response to an operation on the main switch 21 while being reliably separate from the signal path of the main switch 21.

The motor 7 is activated after the dust collection motor 92 is activated in response to an on-operation on the main switch 21.

The dust collection attachment 60 is activated to generate a suction force before the activation of the hammer drill 1. This allows reliable suction of dust simultaneously with the operation of the hammer drill 1.

The dust collection motor 92 is deactivated after the motor 7 is deactivated in response to an off-operation on the main switch 21.

This allows dust to move into the dust box 65 without remaining in the dust collection path R after the hammer drill 1 is deactivated.

The dust collection attachment 60 is vertically movable relative to the hammer drill 1 to be attached to and detached from the hammer drill 1. The dust collection attachment 60 is electrically connected to the hammer drill 1 to activate the responsive unit upon being attached to the hammer drill 1.

The dust collection attachment 60 is thus easily attachable to and detachable from the hammer drill 1. When attached, the dust collection attachment 60 can automatically operate in response to an operation on the main switch 21. This improves usability.

The system includes the indicator lamp 98 to indicate that the battery pack 101 has a power level lower than or equal to a predetermined level.

The operator can thus promptly replace or charge the battery pack 101.

The indicator lamp 98 provides a visual indication.

The operator can thus easily notice a decrease in the power level.

Modifications of the disclosure will now be described.

The subswitch included in the responsive unit may be located below or lateral to the main switch, rather than above the main switch. The structure of the subswitch may also be modified as appropriate.

The responsive unit may have a structure other than the structure with the subswitch. For example, a single switch may have two signal paths that are electrically separate from each other. In this case, a first signal path may be connected to the tool-body controller through the main lead wire, and a second signal path may be connected to the dust collection attachment through the sub-lead wire.

In this structure as well, the DC motor can operate in response to an operation on the switch while being reliably separate from the signal path of the switch for the AC motor.

In the hammer drill, the position and orientation of the motor, the position and orientation of the tool-body controller, and the position at which the power cable is connected are not limited to the above embodiments. For example, the motor may have a rotational shaft extending frontward or diagonally frontward. The tool-body controller may extend laterally. The power cable may be connected to the rear surface of the handle. The tool-body controller may be eliminated.

The structure of the striking assembly is not limited to the above embodiments. The selectable operational modes may include a drill mode.

The power tool is not limited to a hammer drill and may be another power tool such as an electric hammer.

Although the dust suction bit is attached to the power tool as a tip tool in the above embodiments, any tip tool other than the dust suction bit may be attached. In this case, a cylindrical attachment with a hose fitting may be attached to the tip of the power tool to cover the outer surface of the tip tool. The hose fitting may be connected to the suction portion in the dust collection attachment using a flexible hose.

The dust collection attachment may be attached to the power tool in, for example, the front-rear direction, rather than in the vertical direction.

In the dust collection attachment, the position and orientation of the DC motor and the position and structure of the dust box are not limited to the above embodiments. For example, the DC motor may be accommodated with its rotational shaft extending upward or laterally. The DC motor and the fan may have their separate shafts, and a rotation may be transmitted from the rotational shaft of the DC motor to the shaft of the fan.

The dust collector is not limited to a dust box and may have a cyclone structure with no filter. The dust collection path may thus be modified as appropriate.

The battery pack may be slid laterally, rather than from the rear, to be attached to the battery mount. Multiple battery packs may be attached.

In the dust collection attachment, the flexible hose may be connected to, for example, the upper surface or the side surface of the casing, rather than to the front surface. The dust collection attachment may be attached without a flexible hose. For example, the dust collection attachment may include a sliding cylinder defining a dust collection path inside and protruding from the casing. The sliding cylinder may have a suction port at the tip to receive a tip tool.

The indicator is not limited to a lamp and may provide an indication using, for example, display of characters or numbers. The indicator may use a sound, such as an electronic sound, or may use both a lamp and a sound.

### REFERENCE SIGNS LIST

1 hammer drill
2 inner housing
3 motor housing
4 upper outer housing
5 lower outer housing
6 striking assembly
7 motor
8 rotational shaft
11 front cylinder
12 handle
13 tool-body controller
20 power cable
21 main switch
22 subswitch
24 main lead wire
27 sub-lead wire
29 female connector
30 switch lever
35 tool holder
44 piston
48 striker
49 impact bolt
60 dust collection attachment
61 casing
62 main section
65 dust box
71 hook plate
78 male connector
83 filter
92 dust collection motor
94 dust collection fan
96 dust-collector controller
97 signal lead wire
101 battery pack
103 power lead wire
B bit
R dust collection path
S dust collection system for power tool

What is claimed is:

1. A dust collection system for a power tool, the system comprising:
a power tool including
an alternating current motor drivable with a switch, and
a tool-body power path extending from utility power to the alternating current motor; and
a dust collection attachment attachable to the power tool to collect dust produced by the power tool in use, the dust collection attachment including
a suction portion,
a dust collector configured to capture dust sucked through the suction portion,
a fan configured to generate a suction force in the suction portion,
a direct current motor configured to rotate the fan,
a battery pack configured to supply power to the direct current motor, and
a dust-collector power path extending from the battery pack to the direct current motor, the dust-collector power path being electrically separate from the tool-body power path with the dust collection attachment attached to the power tool,
the power tool including a responsive unit configured to drive the direct current motor in response to an operation on the switch with the responsive unit electrically separate from a signal path of the switch.

2. The dust collection system according to claim 1, wherein
the power tool includes a tool-body controller configured to control the alternating current motor in response to an operation on the switch, and
the tool-body power path extends from the utility power to the alternating current motor through the tool-body controller and is electrically separate from the dust-collector power path.

3. The dust collection system according to claim 1, wherein
the responsive unit includes
a second switch on the power tool, the second switch being separate from the switch and operable in response to an operation on the switch, and
a second signal path electrically connecting the second switch and the direct current motor with the dust collection attachment attached to the power tool.

4. The dust collection system according to claim 1, wherein
the responsive unit includes a second signal path separate from the signal path of the switch, and the second signal path electrically connects the switch and the direct current motor with the dust collection attachment attached to the power tool.

5. The dust collection system according to claim 1, wherein
the alternating current motor is activated after the direct current motor is activated in response to an on-operation on the switch.

6. The dust collection system according to claim 1, wherein
the direct current motor is deactivated after the alternating current motor is deactivated in response to an off-operation on the switch.

7. The dust collection system according to claim 1, wherein
the dust collection attachment is vertically movable relative to the power tool to be attached to and detached from the power tool, and
the dust collection attachment is electrically connected to the power tool to activate the responsive unit upon being attached to the power tool.

8. The dust collection system according to claim 1, wherein
the dust collection attachment includes an indicator configured to indicate that the battery pack has a power level lower than or equal to a predetermined level.

9. The dust collection system according to claim 8, wherein
the indicator provides a visual indication.

10. The dust collection system according to claim 2, wherein
the responsive unit includes
a second switch on the power tool, the second switch being separate from the switch and operable in response to an operation on the switch, and
a second signal path electrically connecting the second switch and the direct current motor with the dust collection attachment attached to the power tool.

11. The dust collection system according to claim 2, wherein
the responsive unit includes a second signal path separate from the signal path of the switch, and the second signal path electrically connects the switch and the direct current motor with the dust collection attachment attached to the power tool.

12. The dust collection system according to claim 2, wherein
the alternating current motor is activated after the direct current motor is activated in response to an on-operation on the switch.

13. The dust collection system according to claim 3, wherein
the alternating current motor is activated after the direct current motor is activated in response to an on-operation on the switch.

14. The dust collection system according to claim 4, wherein
the alternating current motor is activated after the direct current motor is activated in response to an on-operation on the switch.

15. The dust collection system according to claim 2, wherein
the direct current motor is deactivated after the alternating current motor is deactivated in response to an off-operation on the switch.

16. The dust collection system according to claim 3, wherein
the direct current motor is deactivated after the alternating current motor is deactivated in response to an off-operation on the switch.

17. The dust collection system according to claim 4, wherein
the direct current motor is deactivated after the alternating current motor is deactivated in response to an off-operation on the switch.

18. The dust collection system according to claim 5, wherein
the direct current motor is deactivated after the alternating current motor is deactivated in response to an off-operation on the switch.

19. The dust collection system according to claim 2, wherein
the dust collection attachment is vertically movable relative to the power tool to be attached to and detached from the power tool, and
the dust collection attachment is electrically connected to the power tool to activate the responsive unit upon being attached to the power tool.

20. The dust collection system according to claim 3, wherein
the dust collection attachment is vertically movable relative to the power tool to be attached to and detached from the power tool, and
the dust collection attachment is electrically connected to the power tool to activate the responsive unit upon being attached to the power tool.
